(19) United States
(12) Patent Application Publication
(10) Pub. No.: US 2021/0049648 A1
(43) Pub. Date: Feb. 18, 2021

(54) SYSTEMS, METHODS AND ARTICLES FOR AUTOMATED AUCTION-BASED MARKETPLACE FOR CONTENT

(71) Applicant: WideOrbit Inc., San Francisco, CA (US)

(72) Inventors: Brian Thoman, Everett, WA (US); William E. Offeman, Redmond, WA (US); Sai-Ming Li, Issaquah, WA (US)

(21) Appl. No.: 16/542,603

(22) Filed: Aug. 16, 2019

(51) Int. Cl. G06Q 30/02

(52) U.S. Cl. CPC G06Q 30/0275; G06Q 30/0272; G06Q 30/0277; G06Q 30/0249

(57) ABSTRACT

Systems, methods and articles for automating and optimizing the buying and selling of content, such as advertising inventory units. The systems disclosed herein provide an automated double-blind auction-based marketplace that provides price protection for buyers, provides advanced insight to buyers regarding future campaign performance, and creates balanced sell side competition. This is achieved by an automated auction engine that, among other things, automatically determines the winning buyers and sellers and automatically determines the prices that winning buyers will pay. The system may automatically generate orders from the winning bids, and the orders may be sent to a traffic system for publishing.

### BACKGROUND

### Technical Field

The present disclosure relates the field of computer technology, and more particularly, to computer systems and methods that facilitate the delivery of content to consumers.

### Description of the Related Art

Content providers such as radio stations and networks, television stations and networks, and Webcasters provide programming including content which is the subject of programming. Content providers' delivery of content is often via broadcasts or Webcasts (collectively, “mediacasts”). While content providers may employ repeaters and the like, broadcasts are typically limited in range to a geographic region.

Programming often includes advertisements interspersed with the subject matter of the programming. The advertisements may occur in segments or slots sometimes referred to as “ad breaks.” Content providers typically sell advertising time to generate revenue to fund operation, as well as generate profits, where the content provider is a commercial entity rather than a nonprofit entity. Given that most broadcasts are local in nature or extent, content providers often carry advertisements and other material which is of a somewhat local or parochial interest. For example, a local chain may place advertisements with a local broadcaster since the audience targeted by the local chain is also often local and local advertising tends to be less expensive than regional or national advertising.

New approaches that automate the various activities related to buying, selling and placement of new materials, for instance, advertisements, in mediacasts are desirable.

### BRIEF SUMMARY

A method to automate advertisement placement in linear mediacasts, may be summarized as including providing an automated auction-based marketplace for advertisement slots within a future time period; receiving, from a plurality of advertisement sellers, a plurality of available inventory units, each of the available inventory units specifying at least one of the advertisement slots and a floor price; receiving, from each of a plurality of advertisement buyers, a plurality of bids for the advertisement slots, each of the bids specifying one or more of the advertisement slots and a maximum cost per mille (CPM) that the advertisement buyer is willing to pay for an advertisement slot; responsive to a tentative auction trigger, executing an auction engine to automatically generate auction results, the auction results indicating, for each advertisement slot, which bid would win which available inventory unit and a price that the winning advertisement buyer would pay for the available inventory unit; presenting the auction results generated responsive to the tentative auction trigger to the advertisement sellers and the advertisement buyers as tentative auction results; responsive to a final auction trigger, executing the auction engine to automatically generate auction results; designating auction results for advertisement slots within a determined time period after the final auction trigger as final auction results; and designating auction results for advertisement slots beyond the determined time period after the final auction trigger as tentative auction results; and presenting the final auction results and the tentative auction results to the advertisement sellers and the advertisement buyers.

The method may further include generating orders based on the final auction results; and sending the generated orders to a traffic management system for publishing.

The method may further include rejecting any bids within the determined time period after the final auction trigger that were not accepted based on the final auction results. Each of the bids may specify at least one of the advertisement slots and a maximum CPM for a household demographic that the advertisement buyer is willing to pay.

The method may further include for each specified maximum CPM, equivalizing the maximum CPM by length of advertisement slot to obtain an equivalized maximum CPM. The auction engine may take into account at least one of a budget of the advertisement buyer, a frequency cap of the advertisement buyer, or a minimum spot frequency count of the advertisement buyer. The auction engine may convert each floor price into equivalized CPM based on impression forecast data and advertisement spot length. Each of the available inventory units may specify seller accept rules that define at least one of advertisement spot lengths the advertisement seller is willing to sell, agencies to exclude, or advertisers to exclude. The floor price specified by at least one of the available inventory units may be a fixed floor price or a dynamic floor price based on previously sold inventory. The final auction trigger may occur on a closing day and, responsive to the final auction trigger, the auction engine generates final auction results for a determined number of days that occur one or more days after the closing day. The tentative auction trigger may occur responsive to at least one of the daily close of the auction marketplace, receiving a bid from an advertisement buyer, or receiving a new accept rule from an advertisement seller. The auction engine may determine the auction results based at least in part on a clearance rate for each of the advertisement sellers, the clearance rate indicative of a percentage of bids previously accepted by the advertisement seller that were actually published. Presenting the tentative auction results may include presenting to the advertisement buyers the number of impressions for each advertisement seller and daypart and an amount of an overall budget that the advertisement buyer has tentatively spent. To determine a price that the winning advertisement buyer would pay for the available inventory unit, the auction engine may take into account at least one of a floor price of a non-winning advertisement seller or the maximum CPM of a non-winning advertisement buyer. The non-winning advertisement seller may be the advertisement seller that has a second lowest floor price, and the non-winning advertisement buyer may be the advertisement buyer that has the second highest maximum CPM. To determine which bid wins which available inventory unit, the auction engine may perform actions including for each of the received bids, equivalizing the maximum CPM to generate a equivalized maximum CPM; ranking the received bids from highest maximum equivalized CPM to lowest maximum equivalized CPM; iteratively for each bid according to the ranked order of the received bids, identifying all eligible available inventory units for the bid; iteratively, until there are no eligible available inventory units for the bid or there is insufficient budget associated with the bid, for each of the eligible available inventory units, converting the floor price to a CPM floor price based on impression forecast data; and generating an adjusted CPM floor price based on a clearance rate for the advertisement seller; sorting the eligible available inventory units by the adjusted CPM floor price from lowest to highest; allocating the eligible available inventory units to the bid based on constraints of the bid; and determining a price for each of the allocated advertisement inventory units. To determine a price that the winning advertisement buyer would pay for the available inventory unit, the auction engine may perform actions including if there is both a second lowest seller floor price and a second highest maximum CPM, setting the price equal to the mean of the second lowest seller floor price and the second highest maximum CPM adjusted by a first adjustment factor; if there is not a second lowest seller floor price and there is a second highest maximum CPM, setting the price equal the mean of the lowest seller floor price and the second highest maximum CPM adjusted by a second adjustment factor; if there is a second lowest seller floor price and there is not a second highest maximum CPM, setting the price equal to the second lowest seller floor price; and if there is not a second lowest seller floor price and there is not a second highest maximum CPM, setting the price equal to the lowest seller floor price. The floor prices may be adjusted CPM floor prices, and the maximum CPMs may be equivalized maximum household CPMs. The first adjustment factor may be one of multiplied by or added to the mean of the second lowest seller floor price and the second highest maximum CPM, the second adjustment factor is one of multiplied by or added to the mean of the lowest seller floor price and the second highest maximum CPM, and each of the first and second adjustment factors is zero, a positive number, or a negative number. The first adjustment factor may be equal to the second adjustment factor. The first adjustment factor and the second adjustment factor may include randomly generated numbers.

A system to optimize advertisement placement in linear mediacasts for a seller of advertisements, may be summarized as including at least one nontransitory processor-readable storage medium that stores at least one of instructions or data; and at least one processor communicatively coupled to the at least one nontransitory processor-readable storage medium, in operation, the at least one processor provides an automated auction-based marketplace for advertisement slots within a future time period; receives, from a plurality of advertisement sellers, a plurality of available inventory units, each of the available inventory units specifying at least one of the advertisement slots and a floor price; receives, from each of a plurality of advertisement buyers, a plurality of bids for the advertisement slots, each of the bids specifying one or more of the advertisement slots and a maximum cost per mille (CPM) that the advertisement buyer is willing to pay for an advertisement slot; responsive to a tentative auction trigger, executes an auction engine to automatically generate auction results, the auction results indicating, for each advertisement slot, which bid would win which available inventory unit and a price that the winning advertisement buyer would pay for the available inventory unit; presents the auction results generated responsive to the tentative auction trigger to the advertisement sellers and the advertisement buyers as tentative auction results; responsive to a final auction trigger, executes the auction engine to automatically generate auction results; designates auction results for advertisement slots within a determined time period after the final auction trigger as final auction results; and designates auction results for advertisement slots beyond the determined time period after the final auction trigger as tentative auction results; and presents the final auction results and the tentative auction results to the advertisement sellers and the advertisement buyers.

A nontransitory processor-readable storage medium that stores at least one of instructions or data, the at least one nontransitory processor-readable storage medium, when executed by at least one processor, may cause the at least one processor to provide an automated auction-based marketplace for advertisement slots within a future time period; receive, from a plurality of advertisement sellers, a plurality of available inventory units, each of the available inventory units specifying at least one of the advertisement slots and a floor price; receive, from each of a plurality of advertisement buyers, a plurality of bids for the advertisement slots, each of the bids specifying one or more of the advertisement slots and a maximum cost per mille (CPM) that the advertisement buyer is willing to pay for an advertisement slot; responsive to a tentative auction trigger, execute an auction engine to automatically generate auction results, the auction results indicating, for each advertisement slot, which bid would win which available inventory unit and a price that the winning advertisement buyer would pay for the available inventory unit; present the auction results generated responsive to the tentative auction trigger to the advertisement sellers and the advertisement buyers as tentative auction results; responsive to a final auction trigger, execute the auction engine to automatically generate auction results; designate auction results for advertisement slots within a determined time period after the final auction trigger as final auction results; and designate auction results for advertisement slots beyond the determined time period after the final auction trigger as tentative auction results; and present the final auction results and the tentative auction results to the advertisement sellers and the advertisement buyers.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of a networked environment, including an automated advertisement purchase computer system that includes an auction engine communicatively coupled between sellers, such as terrestrial radio or television providers or Webcasters, and buyers, such as advertisers or agencies who have advertisements to place or who otherwise control placement of advertisements, according to one illustrated implementation.

FIG. 2 is a block diagram that shows an example hybrid style pricing model for the auction engine shown in FIG. 1, according to one illustrated implementation.

FIG. 3 is a table that shows example formulas for determining the price that a winning buyer pays for an advertisement slot, according to one non-limiting illustrated implementation.

FIG. 4 is a screenshot of an example sell side auction-based marketplace user interface for an automated advertisement purchase system, according to one non-limiting illustrated implementation.

FIG. 5 is a screenshot of an example edit acceptance rule user interface for an automated advertisement purchase system, showing a rule setup window, according to one non-limiting illustrated implementation.

FIG. 6 is a screenshot of an example new acceptance rule user interface for an automated advertisement purchase system, showing a frequency capping window that allows sellers to establish various frequency caps, according to one non-limiting illustrated implementation.

FIG. 7 is a flow diagram showing a method of operating an auction engine of an automated advertisement purchase system to generate tentative auction results, according to one non-limiting illustrated implementation.

FIG. 8 is a flow diagram showing a method of operating an auction engine of an automated advertisement purchase system to generate final auction results and tentative auction results, according to one non-limiting illustrated implementation.

FIG. 9 is a flow diagram showing a method of operating an auction engine of an automated advertisement purchase system to determine a winning buyer, according to one non-limiting illustrated implementation.

FIG. 10 is a schematic diagram of an example computing environment in which one or more systems and methods of the present disclosure may be implemented, according to one non-limiting illustrated implementation.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

One or more implementations of the present disclosure are directed to computer-implemented systems and methods of automating and optimizing the buying and selling of advertisements, or “spots.” Buying and selling television, radio or digital advertising has traditionally been a highly manual process and requires many participants to execute orders. Layering in audience and pricing data adds another level of complexity to the campaign execution workflow.

In conventional workflows, if an advertiser operates in 20 markets and wants to advertise locally in those markets, a representative of the advertiser contacts (e.g., calls, emails) multiple networks in each of the 20 markets to negotiate and purchase advertising. In this example, if the advertiser wants to inquire about or purchase advertising with 5 to 7 networks in each of the 20 markets, the advertiser would need to manually contact and negotiate with 100-150 networks, which is an extremely time consuming and inefficient process.

Implementations of the present disclosure are directed to computer-implemented systems and methods for providing an autonomous advertisement purchase system where buyers can automatically receive offers for advertisement placement opportunities simultaneously via a single interface, and the system automates selection of the received offers using an auction engine that in at least some embodiments implements a double-blind auction. Thus, the aforementioned manual and inefficient process is automated and provides optimization that was previously not possible using conventional workflows.

In at least some implementations, buyers and sellers can trade mediacast (e.g., broadcast, Webcast) advertisement inventory (e.g., direct or programmatically) at local, national, and/or worldwide levels. The types of media traded via may simultaneously include numerous types of media, including TV, cable, satellite, radio, outdoor, print, etc. Such programmatic advertising implements data-driven automation of audience-based advertising operations which inverts the industry standard in which marketers rely on show ratings to determine desirable audiences for the marketers' advertisements. Instead, with programmatic, marketers may use audience data to pipe advertising to optimal places. For example, marketers may use programmatic technology to reach a more specific set of consumers regardless of on which programs the advertisements appear.

In at least some implementations, the systems of the present disclosure seamlessly blend traditional linear media (e.g., TV, cable, satellite, radio, outdoor, print) sales practices with data-driven digital advertisement buying methods. In some implementations, the systems are fully automated seller-controlled advertisement purchase systems which connect local mediacasters (e.g., broadcasters, Webcasters, printed content providers) with new and existing demand sources and offer revenue management tools for optimizing yields across direct and programmatic channels. Transactions may be demandled, which allows sellers to view the demand across the sellers' entire landscape of potentially available advertisement inventory. Further, in some implementations, the sellers may accept or reject bid responses from buyers without revealing price floors or available advertisement opportunities to any of the buyers.

In at least some implementations, the advertisement purchase systems disclosed herein interface with demand side platforms (DSPs) that make automated media advertisement purchases. Sellers enjoy seamless transaction workflow for getting advertisements from proposal, to publishing, and to billing that delivers a significant reduction in time spent on reconciliation and “make-goods” and streamlines processes for creative management and revenue management across direct and programmatic sales channels.

In some implementations, the advertisement purchase systems include powerful yield management tools that give participating sellers the power to retain full control of pricing floors and inventory allocation across direct and programmatic sales channels. The advertisement purchase systems may also honor all placement rules for delivery separation and automatic management of potential channel conflict across advertisements sold directly and through the advertisement purchase system.

The advertisement purchase systems may include a seller side platform (SSP) or console for sellers (e.g., broadcasters, Webcasters, printed content providers) and an advertiser-facing interface or console for demand side platform (DSP) entities to interface with the advertisement purchase systems. Through the SSP, sellers can access demand and make advertisement inventory available and accept or reject bid responses based on marketplace demand.

The advertiser-facing interface facilitates creative placement and reviewing for the buy side, and may have transcoding and approval tools for the sell side. For example, in some implementations, once an advertisement transaction is approved, the advertiser-facing interface sends the advertisement directly to a broadcaster's traffic system. In some implementations, the advertisement purchase system is a sell-side powered marketplace, which allows sellers to set price floors and to retain the right to accept or reject any offer which comes through the advertisement purchase system.

In some implementations, the advertisement purchase systems disclosed herein automate aspects of billing, reconciliation, and creative execution. In some implementations, the advertisement purchase systems may be integrated with advertisement management software and sales and traffic management systems.

In one or more implementations disclosed herein, the systems do not require sellers to offer particular day parts or times when advertisement inventory is available. That is, “carve-outs” are not required. Rather, buyers can extend offers for the entire roster or landscape for a particular channel for a particular period of time (e.g., mediacast day). Thus, sellers may peruse this demand and decide which offers to accept or not to accept.

As discussed further below, in some implementations, the advertisement inventory is bought and sold as canonical inventory units which group similar but discrete advertisement slots together. For example, for linear media an inventory unit may be defined as a specific channel, day and time period (e.g., 30 minutes). Buyers may price the inventory units and provide a bid for any of the inventory units.

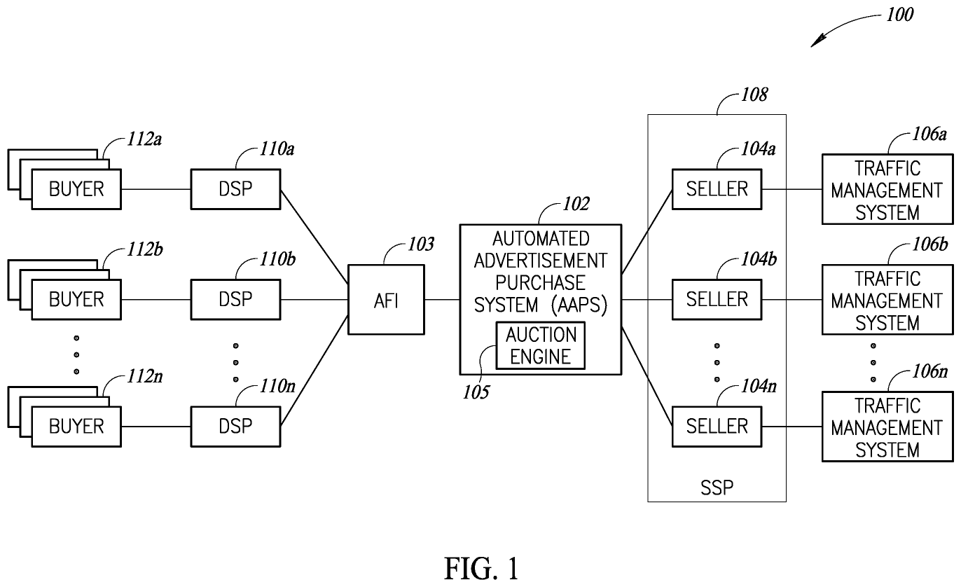

FIG. 1 shows an example networked environment 100 according to one illustrated implementation in which various apparatus, methods and articles described herein may operate. The environment 100 includes an advertisement purchase or exchange system 102 that includes an auction engine 105, discussed below, an advertiser-facing interface (AFI) 103, a number of sellers or content providers 104A-104N (collectively 104), traffic management systems 106A-106N (collectively 106), a supply side platform (SSP) 108, a number of demand side platforms (DSPs) 110A-110N (collectively 110), and a number of buyers 112A-112N (collectively 112), such as advertisers or agencies, all communicatively coupled by one or more networks or other communications channels. The various components of the environment may be distributed or integrated in any number of ways. For example, in at least some implementations, two or more of the DSPs 110, AFI 103, automated advertisement purchase system 102, SSP 108 and traffic management system 106 may be integrated into a single platform provided by one or more entities.

The sellers 104 may take a variety of forms, for example, radio stations or broadcasters, television stations or broadcasters, other terrestrial or satellite broadcasters or multicasters (not shown), Webcasters, printed content (e.g., print media) providers, outdoor content (e.g., billboards) providers, etc. The sellers 104 may, or may not, own the content that they provide. The sellers 104 utilize the SSP 108 to access the advertisement purchase system 102 and may use the traffic management systems 106A-106N for traffic management. On the buy side, the buyers 112 (e.g., advertisers, agencies) may interface with the system 102 via the AFI 103 through the buyers' respective DSPs 110.

With presently available systems, it is difficult for advertisers to spend their budgets easily. Further, advertisers may be unwilling to enter into a marketplace due to limited pricing discovery options. Other issues exist that include media prices that are too high due to cherry-picking by sellers, seller competition that favors one region (e.g., East coast) over other regions, and sellers competing for dollars instead of delivery.

To address these and other issues, one or more implementations of the present disclosure provide price protection and minimum frequency protection for buyers. The systems and methods disclosed herein may also provide better insight to buyers on future performance, which enables campaign management for the buyers and allows them to be able to manage their spend. The systems and methods also create more balanced sell side competition by rewarding sellers with a high clearance rate, which is the percentage of billable versus unbillable accepted inventory units a seller has had in the past.

In at least some implementations, a system is provided that implements an auction engine that automatically receives bids for advertisement slots in an auction-based marketplace and determines winners based on various criteria, as discussed in detail below. In at least some implementations, the auction-based marketplace may be combined with a manual acceptance marketplace that allows manual acceptance of bids. For example, buyers may submit bids to the manual acceptance marketplace, and sellers may be notified about the demand and may view the half hours with uplift and manually accept individual half hours or choose a larger area to rotate across. The manual acceptance marketplace may close every day, which causes bids that were not accepted to be rejected. The system may allow auto acceptance rules that are used to automatically accept offers within certain thresholds and boundaries.

To implement the auction-based marketplace, the number of days into the future that bids may be manually accepted may be limited. For dates further into the future, an auction may be implemented that commits on a weekly basis (or on another basis), and automatically calculates the winner for each agency bid and determines the price that the buyer will pay.

In at least some implementations, the manual acceptance marketplace and the auction-based marketplace operate independently of each other, but once the auction-based marketplace commits for a broadcast week, the dates in that week become available for manual acceptance in the manual acceptance marketplace. As a non-limiting example, the manual acceptance marketplace bids may be visible from a “minimum days to air” date to the end of the next committed auction-based marketplace broadcast week. As an example, the next broadcast week may commit the Wednesday before. Thus, for example, if the current day is Monday then the manual acceptance marketplace runs to the following Sunday because the next week has not closed yet. Conversely, if the current day is Thursday, then the manual acceptance marketplace runs through the Sunday of the following week because the next week committed the day before (Wednesday).

When an auction-based marketplace broadcast week commits, the auction engine may run one final time and then lock in the won bids and the buyer's price. Manual acceptances may not be allowed for dates that have not been committed in the auction-based marketplace. In at least some implementations, bids can be submitted to the manual acceptance marketplace for dates that have not committed in the auction-based marketplace yet, but those bids may not be shown to the sellers until that week is committed in the auction-based marketplace.

As noted above, the auction-based marketplace may allow buyers submit bids into a double-blind auction instead of a manual acceptance calendar. A seller may use accept rules, discussed further below, to define the boundaries of the inventory available to sell, who they are willing to sell to, and sellers may set a floor price or use a dynamic floor price that varies based on previously sold inventory. Buyers may create advertisement groups (“ad groups”) that specify various criteria for the types of advertisement slots they want to buy, and the prices they are willing to pay. Instead of presenting the bids to the sell side and letting the sellers accept the bids, the auction-based marketplace runs the bids through the auction engine to determine which channel/day/half hours win each bid and how much the winning buyer pays.

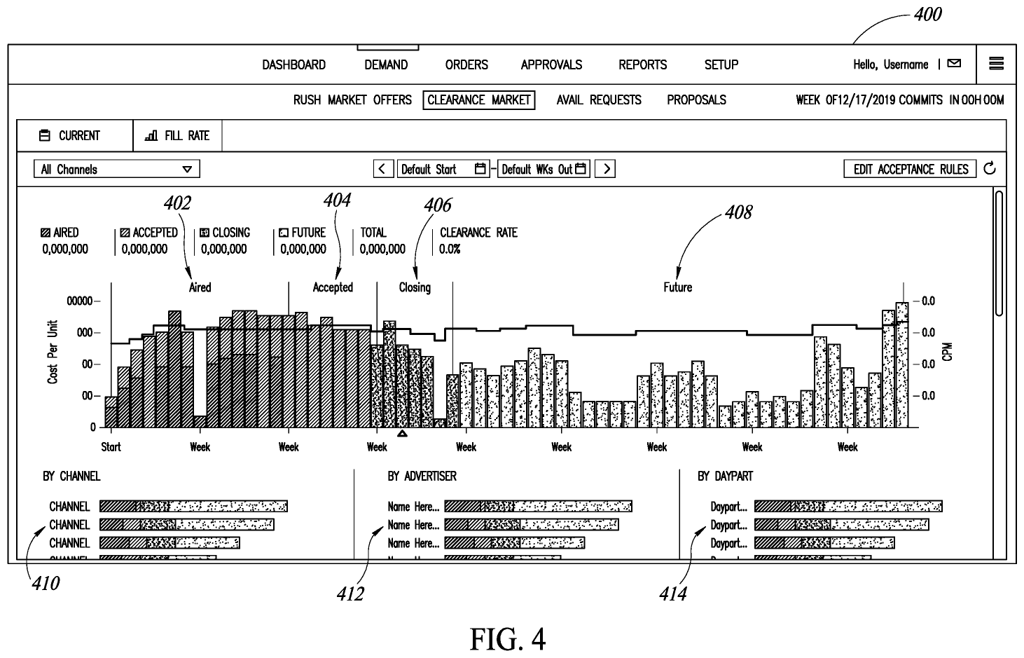

As noted above, in at least some implementations the auction-based marketplace commits one week at a time on a Wednesday (or other day) before the air week (Monday-Sunday). Before the week closes, spots are in a tentative acceptance state, which means that the spots are not accepted and the sellers are not committed to air yet. During this time period, buyers and sellers may view the tentative acceptances and see the number of impressions for each station and daypart and the overall budget that has been tentatively spent (see FIG. 4). At the end of the day on Wednesday, the auction engine runs one final time and commits the tentative acceptances for the next Monday-Sunday week.

The auction engine may run in one or more of the following situations to recalculate the spots that will be trial accepted and at what rate: every one day at a time when the marketplace closes; when a new ad group's bids are submitted for the first time; or when a new rule is created by a seller.

Trial acceptance for a broadcast week commits the previous Wednesday, giving stations four days before air. Trial acceptance calculations may occur into the future as far as bids have been submitted. When the auction-based marketplace commits a week, the auction engine runs one more time, the results of the auction are committed to acceptances, orders are created for the acceptances, and all non-accepted bids submitted for the week are rejected. The orders may then be sent to a traffic system for publishing.

In at least some implementations, when buyers are creating a new ad group, buyers may enter a household cost per mille (CPM) instead of a CPM for a target demographic. Once the buyer submits bids to the auction-based marketplace, the auction engine is triggered to run. As mentioned above, the auction engine may re-run once per day or when a new ad group submits bids. The results of the auction engine may then be presented in both the DSP 110 and the SSP 108 for viewing by the buyers and sellers, respectively. The budget is deducted from the bid groups when a spot is trial accepted and held until the next recalculation, when the amount held may change based on new bids, changes to ad groups, or changes to acceptance rules since the last run of the auction engine. Buyers and sellers may be able to see how many impressions are tentatively accepted but, in at least some implementations, are only able to see the total budget tentatively accepted on a week level.

At the end of the day on a Wednesday (or other commit day), the auction engine runs one final time for the next Monday-Sunday week and commits the acceptances.

Orders are then created for the committed acceptances, and are sent to a traffic system manually or automatically based on station configuration settings. The spots sent to the traffic system are then aired. Airtimes are generated and spots are marked as billable or not billable based on whether they aired or aired in the purchased date/half hour, and the buyers may then be billed for the aired spots.

The auction engine 105 of the present disclosure provides various advantageous outcomes including, but not limited to: encouraging high CPM bids from buyers; encouraging low floor prices from sellers; encouraging high clearance rates by sellers; limiting gaming opportunity, meaning users cannot easily figure out information about the other members of the marketplace; eliminating the need for sellers to race to accept bids; and significantly improving the flexibility provided to buyers, such as accepting rotations automatically. Further, using the auction engine 105, buyer bid changes should generally not change their clearance price, only their win rate, and buyers should generally pay an effective CPM (eCPM) that is less than their bid, as forecasted by a data management platform (DMP). Moreover, sellers should generally make more than their floor price.

In at least some implementations, the auction engine may utilize some or all of the following inputs: the maximum equivalized household CPM for each ad group; forecast household (or target demographic) impressions for all eligible inventory units; buyer budget; buyer frequency cap; buyer minimum spot frequency cap; seller floor price; seller acceptance rule parameters; and station clearance rate. The ad group with the highest maximum equivalized household CPM may be given the highest priority in the auction. The ad group CPM may be equivalized by spot length. The seller floor price may be converted to CPM using a household or target demographic impression forecast and spot length. The seller acceptance rule parameters may include, for example, inventory units the seller wants to offer, spot lengths (e.g., 15 seconds, 30 seconds) the seller is willing to air, list of agencies to exclude, list of advertisers to exclude, etc.

To determine the winner of an auction, the auction engine may first determine the ad group with the highest equivalized household CPM. Then, the auction engine may find all eligible inventory units (day/half hour) from all stations targeted by the ad group. If there are no eligible inventory units, the auction engine may find all eligible inventory units for the ad group with the second highest equivalized household CPM, etc.

The auction engine may then convert the floor price of each eligible inventory unit into CPM based on household impressions. As discussed further below, the auction engine may calculate an adjusted floor price for each inventory unit by dividing the CPM floor price for the inventory unit by the seller's clearance rate. For example, a $90 CPM and a 0.8 clearance rate provides an adjusted floor price of $112.50 ($90/0.8=$112.50).

The auction engine may then sort the inventory units by adjusted for price from lowest to highest, and then determine which inventory units should be allocated to the ad group given the ad group's constraints. It is noted that more than one spot may be allocated to the ad group in each auction run.

The auction engine may then determine the final CPM and cost for the allocated spots, as discussed further below. This process may be repeated until there is no eligible spot for that ad group or the ad group does not have enough budget for any eligible spot. Then, the auction engine may move on to the ad group with the next highest equivalized CPM, and repeat the process for all of the ad groups.

As noted above, in at least some implementations the auction engine may utilize clearance-based floor adjustment, which adjusts CPM floors for stations based on the percentage of billable versus unbillable accepted inventory units they have had in the past (e.g., past month, past quarter, past year). This percentage is referred to as the “clearance rate.” As an example, if 80% of accepted spots were billable in the past, the clearance rate for the seller is 0.8. The clearance rate may be used to adjust the CPM floor. If the clearance rate is low for a station, it will increase the station's adjusted floor price, which makes the station less competitive in the marketplace because inventory is sorted by lowest to highest CPM floor, as discussed above.

Initially, the original CPM floor is calculated for each station using the following formula: Original CPM Floor=Floor Price/(Household Impressions/1000). Then, the adjusted CPM floor is calculated using the following formula: Adjusted CPM Floor=Original CPM floor/Clearance Rate. Finally, the amount a winning buyer pays is calculated, as discussed further below.

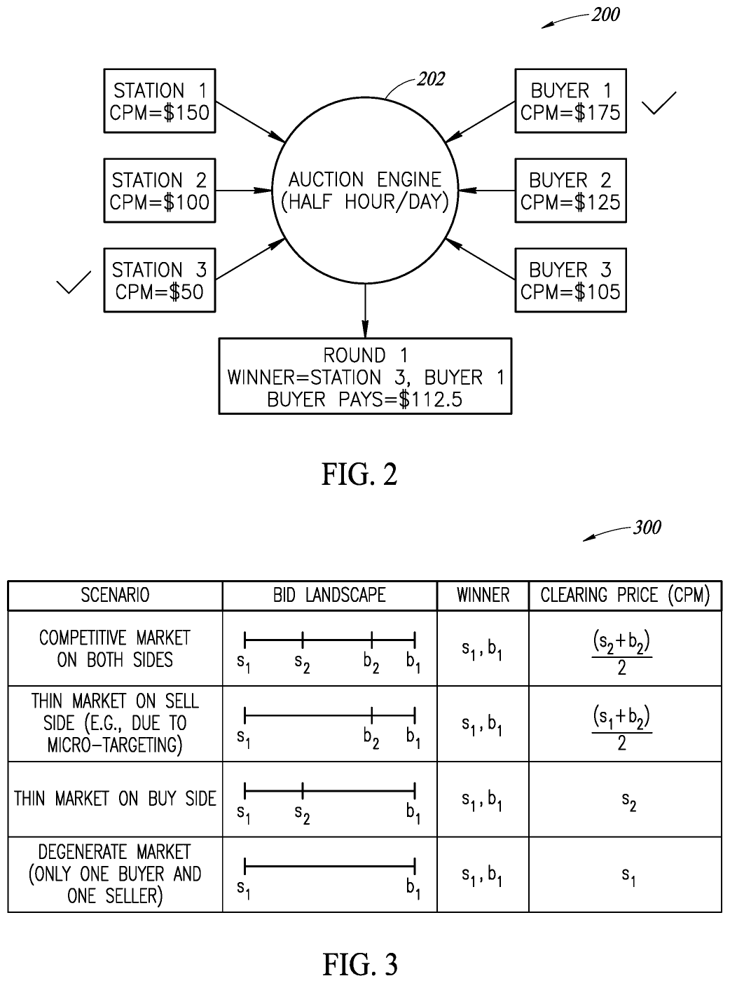

FIG. 2 is a schematic diagram 200 which shows how an auction engine 202, which may be similar or identical to the auction engine 105 of FIG. 1, determines the winner of an example auction for a particular day/half hour. In this example, there are three sellers or stations, Station 1, Station 2, and Station 3, and three buyers, Buyer 1, Buyer 2, and Buyer 3. Station 1 has a CPM floor of $150, Station 2 has a CPM floor of $100, and Station 3 has a CPM floor of $50. Buyer 1 has a maximum CPM price of $175, Buyer 2 has a maximum CPM price of $125, and Buyer 3 has a maximum CPM price of $105. Thus, Station 3 and Buyer 1 are the winners of the auction, since Station 3 has the lowest CPM floor and Buyer 1 has the highest maximum CPM price. In the example of FIG. 2, it is shown that the Buyer 1 will pay $112.50, which is determined using a formula discussed below with reference to FIG. 3.

FIG. 3 illustrates a table 300 that provides example formulas for determining the price that a winning buyer will pay in various market scenarios. In the table, seller s₁ represents the seller with the best (lowest) adjusted CPM floor among all of the accepted sellers; seller s₂ represents the seller with the next best (second lowest) adjusted CPM floor among all of the losing sellers; buyer b₁ represents the buyer with the highest maximum Household CPM; and buyer b₂ represents the buyer with the second highest maximum Household CPM. Seller s₁ and buyer b₁ are always determined to be the winners, but the CPMs for seller s₂ and buyer b₂ are used to calculate the final price in some of the scenarios shown in the table 300 of FIG. 3. In at least some implementations, the sellers' original CPM floor prices are used to determine the price that a buyer pays. In other implementations, the sellers' adjusted CPM floor prices are used to determine the price that a buyer pays.

As shown in the table 300, for a competitive market with at least two sellers s₁ and s₂ and at least two buyers b₁ and b₂, the price is the mean of the CPM floor of seller s₂ and the maximum CPM of the buyer b₂. For a thin market on the sell side where there is only one seller s₁ and there are at least two buyers b₁ and b₂, the price is the mean of the CPM floor of seller s₁ and the maximum CPM of the buyer b₂. For a thin market on the buy side, the price is equal to the CPM floor of the seller 52. For a degenerate market with only one buyer b₁ and one seller s₁, the price is the CPM floor of the seller s₁. In at least some implementations, the price that a buyer pays may be adjusted from the formulas in table 300 by an adjustment factor to prevent users from gaming the system. The adjustment factor may be added or multiplied by the determined prices shown in the table, and may be zero (i.e., no adjustment), a negative value, or positive value. The adjustment factor may a random number that is generated for each calculation or for a group of calculations. The adjustment factor may be constrained so that the final price falls within a determined range. For example, for a competitive market with at least two buyers and at least two sellers, the adjustment factor may be constrained so that the final price is not lower than the CPM floor of the seller s₂ or higher than the maximum CPM of the buyer b₂. Similarly, for a thin market on the sell side, the adjustment factor may be constrained so that the final price is not lower than the CPM floor of the seller s₂ or higher than the maximum CPM of the buyer b₁.

In at least some implementations, the spot lengths may be normalized or equivalized. As an example, all spot lengths may be considered to have the same impressions delivery. Sellers may be able to indicate what factor to use to convert rates between different spot lengths. All CPMs may be equivalized to the CPM corresponding to the spot length of the ad group under consideration to compare in the auction engine.

In the manual acceptance marketplace, buyers may be able to enter a CPM for their target demographic, which works well because different ad groups are competing on price and sellers can pick and choose whatever bid they want. In the auction-based marketplace, the auction engine is making the decisions on who the winner is and the final purchase price, so it is beneficial to provide level playing field. Thus, in at least some implementations, instead of entering a target demographic CPM, for auction-based marketplace ad groups, the buyer may enter a CPM for the Household demographic, referred to herein as Household CPM. The auction engine then converts the seller floor prices to CPMs using Household impressions, which allows the auction engine to compare between ad groups with different demographics and with other sellers. It is noted that in at least some implementations, the system allows buyers to choose target demographics to use for inventory targeting and can view reporting for their target demographics.

FIG. 4 is a screenshot of an example auction-based marketplace user interface 400 for an automated advertisement purchase system, such as the automated advertisement purchase system 102 of FIG. 1, according to one non-limiting illustrated implementation. The user interface 400 graphically shows a seller information about spots that have aired 402, spots that have been accepted 404, spots that are closing 406, and future spots 408. The user interface 400 also provides sales information by channel 410, by advertiser 412, and by daypart 414.

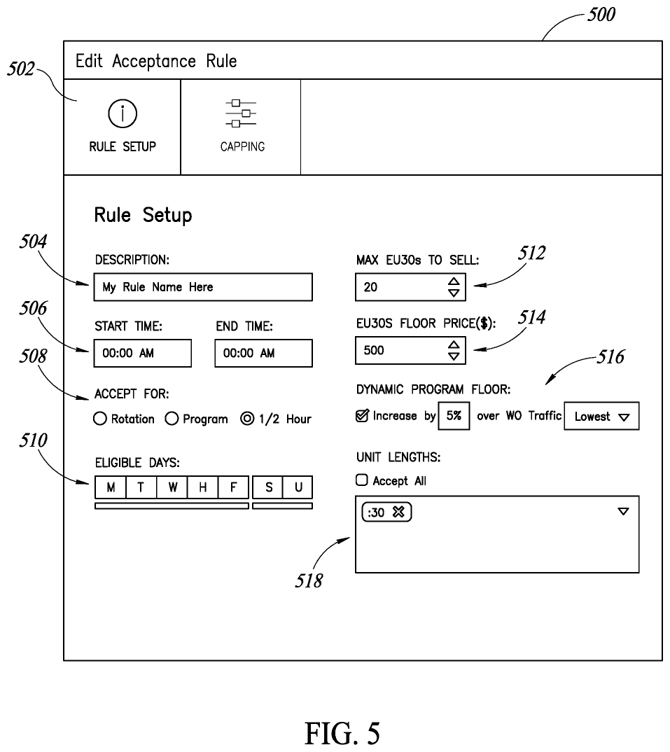

FIG. 5 is a screenshot of an example edit acceptance rule user interface 500 for an automated advertisement purchase system, showing a rule setup window 502, according to one non-limiting illustrated implementation. The rule setup window 502 includes a description box 504 wherein a user can type in a description for an acceptance rule. The rule setup window 502 also includes start/end time boxes 506 and selection buttons 508 that allow for acceptances for a rotation, a program or a half hour. The rule setup window 502 also allow the user to select eligible days 510, the maximum number of 30 second spots to sell 512, the floor price for 30 second spots 514, dynamic floor pricing 516, and unit lengths 518 to accept. The dynamic floor pricing 516 may be based on previously sold inventory identified by a traffic system. In the example shown in FIG. 5, the dynamic floor price is set to 5% over the lowest price sold in the traffic system. The user may select different percentages, and whether the percentage is over the lowest price or other prices in the traffic system, such as highest price, average price, median price, etc.

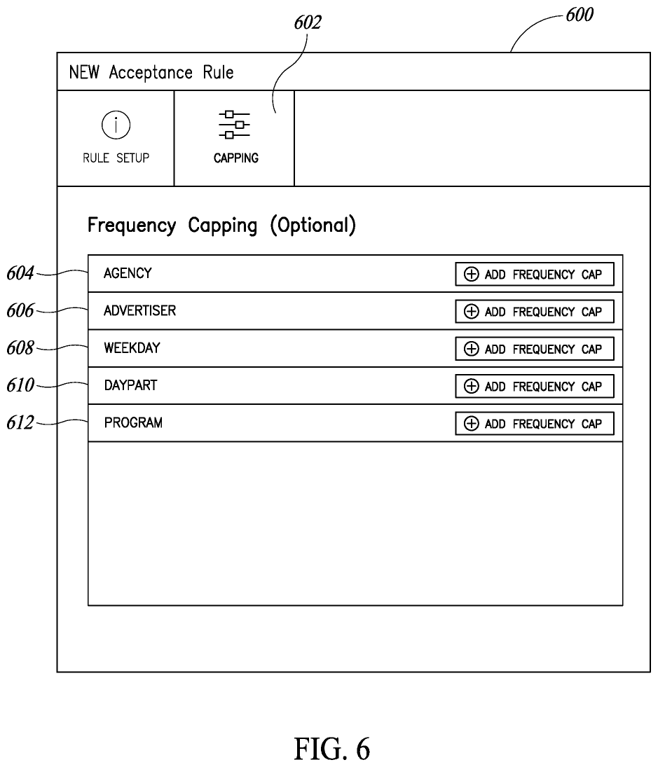

FIG. 6 is a screenshot of an example new acceptance rule user interface 600 for an automated advertisement purchase system, showing a frequency capping window 602 that allows the seller to place various frequency caps, according to one non-limiting illustrated implementation. In this non-limiting example, the frequency capping window 602 allows a seller to place frequency caps specific to agencies 604, advertisers 606, weekdays 608, dayparts 610, or programs 612.

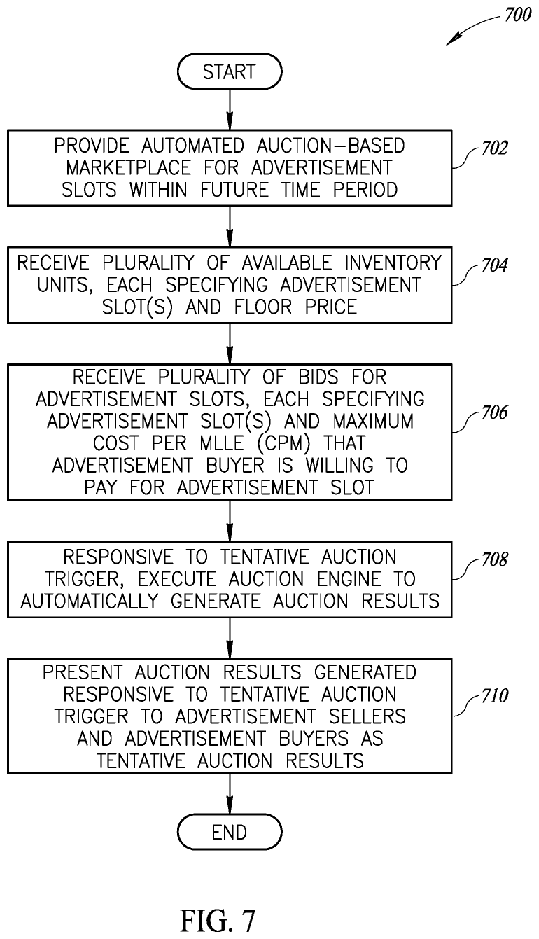

FIG. 7 is a flow diagram showing a method 700 of operating an auction engine of an automated advertisement purchase system, such as the automated advertisement purchase system 102 of FIG. 1, according to one non-limiting illustrated implementation. After a start block, the method 700 begins at 702 wherein the system provides an automated auction-based marketplace for advertisement slots within a future time period (e.g., one week, several weeks, several months). At 704, the system receives, from a plurality of advertisement sellers, a plurality of available inventory units. Each of the available inventory units may specify at least one of the advertisement slots and a floor price. In at least some implementations, each of the available inventory units specifies seller accept rules that define at least one of: advertisement spot lengths the advertisement seller is willing to sell, agencies to exclude, advertisers to exclude, etc. As discussed above, the floor price specified by at least one of the available inventory units may be a fixed floor price or a dynamic floor price based on previously sold inventory.

At 706, the system receives, from each of a plurality of advertisement buyers, a plurality of bids for the advertisement slots. Each of the bids may specify one or more of the advertisement slots and a maximum cost per mille (CPM) that the advertisement buyer is willing to pay for an advertisement slot. In at least some implementations, each of the bids specifies at least one of the advertisement slots and a maximum CPM for a household demographic that the advertisement buyer is willing to pay. For each specified maximum CPM, the system may equivalize the maximum CPM by length of advertisement spot to obtain a equivalized maximum CPM.

At 708, responsive to a tentative auction trigger, the system may execute an auction engine to automatically generate auction results. The auction results may indicate, for each advertisement slot, which bid would win which available inventory unit and a price that the winning advertisement buyer would pay for the available inventory unit. In at least some implementations, the auction engine takes into account at least one of: a budget of the advertisement buyer, a frequency cap of the advertisement buyer, or a minimum spot frequency count of the advertisement buyer. The auction engine may convert each seller floor price into equivalized CPM based on impression forecast data and advertisement spot length. The tentative auction trigger may occur responsive to at least one of: the daily close of the auction marketplace, receiving a bid from an advertisement buyer, or receiving a new accept rule from an advertisement seller.

As discussed above, the auction engine may determine the auction results based at least in part on a clearance rate for each of the advertisement sellers. The clearance rate may be indicative of a percentage of bids previously accepted by the advertisement seller that were actually published. Further, to determine a price that the winning advertisement buyer would pay for the available inventory unit, the auction engine may takes into account at least one of: a floor price of a non-winning advertisement seller or the maximum CPM of a non-winning advertisement buyer. The non-winning advertisement seller may be the advertisement seller that has a second lowest floor price, and the non-winning advertisement buyer may be the advertisement buyer that has the second highest maximum CPM.

In at least some implementations, to determine a price that the winning advertisement buyer would pay for the available inventory unit, the auction engine performs actions dependent on whether the market is competitive or degenerate. For example, if there is both a second lowest seller floor price and a second highest maximum CPM, the system may set the price equal to the mean of the second lowest seller floor price and the second highest maximum CPM adjusted by a first adjustment factor. If there is not a second lowest seller floor price and there is a second highest maximum CPM, the system may set the price equal the mean of the lowest seller floor price and the second highest maximum CPM adjusted by a second adjustment factor. If there is a second lowest seller floor price and there is not a second highest maximum CPM, the system may set the price equal to the second lowest seller floor price. Lastly, if there is not a second lowest seller floor price and there is not a second highest maximum CPM, the system may set the price equal to the lowest seller floor price. As discussed elsewhere herein, the floor prices may be adjusted CPM floor prices, and the maximum CPMs may be equivalized maximum household CPMs. The first adjustment factor may be one of multiplied by or added to the mean of the second lowest seller floor price and the second highest maximum CPM, and the second adjustment factor may be one of multiplied by or added to the mean of the lowest seller floor price and the second highest maximum CPM. Each of the first and second adjustment factors may be zero, a positive number, or a negative number. In at least some implementations, the first adjustment factor is equal to the second adjustment factor. The adjustment factors may be random nor non-random values.

At 710, the system may present the auction results generated responsive to the tentative auction trigger to the advertisement sellers and the advertisement buyers as tentative auction results. As an example, the system may present to the advertisement buyers the number of impressions for each advertisement seller and daypart and an amount of an overall budget that the advertisement buyer has tentatively spent.

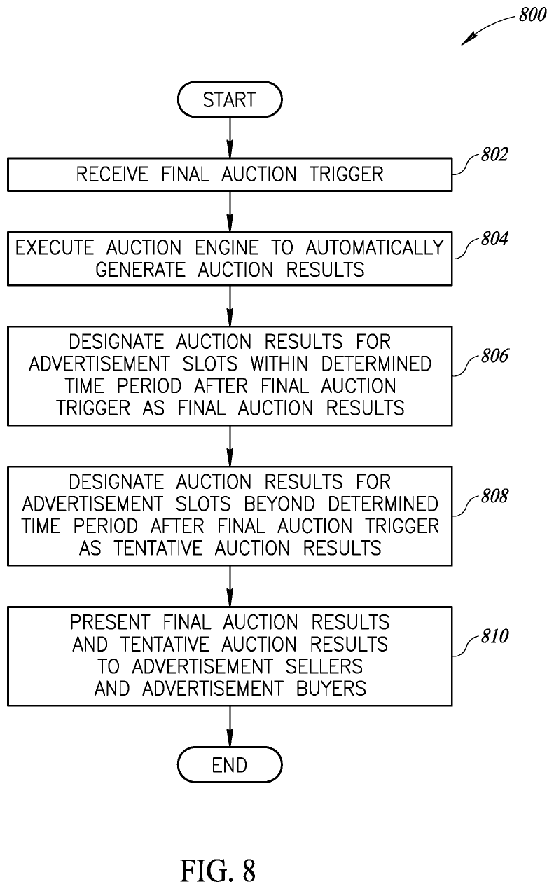

FIG. 8 is a flow diagram showing a method 800 of operating an auction engine of an automated advertisement purchase system to generate final auction results and tentative auction results, according to one non-limiting illustrated implementation. At 802, the system may receive a final auction trigger, for example, on the closing day for a broadcast week as discussed above. Responsive to the final auction trigger, the auction engine may generate final auction results for a determined number of days that occur one or more days after the closing day. For example, a final auction trigger may be received on a Wednesday, and the auction engine may generate final auction results for seven days (Monday-Sunday) that occur five days (Monday following the closing day (Wednesday).

At 804, the system may execute the auction engine to automatically generate auction results, as discussed above.

At 806, the system may designate auction results for advertisement slots within a determined time period after the final auction trigger as final auction results, and at 808 may designate auction results for advertisement slots beyond the determined time period after the final auction trigger as tentative auction results.

At 810, the system may present the final auction results and the tentative auction results to the advertisement sellers and the advertisement buyers. In at least some implementations, the system may automatically generates orders based on the final auction results, and then send the generated orders to a traffic management system for publishing. Further, after the auction has closed, the system may reject any bids within the determined time period after the final auction trigger that were not accepted based on the final auction results.

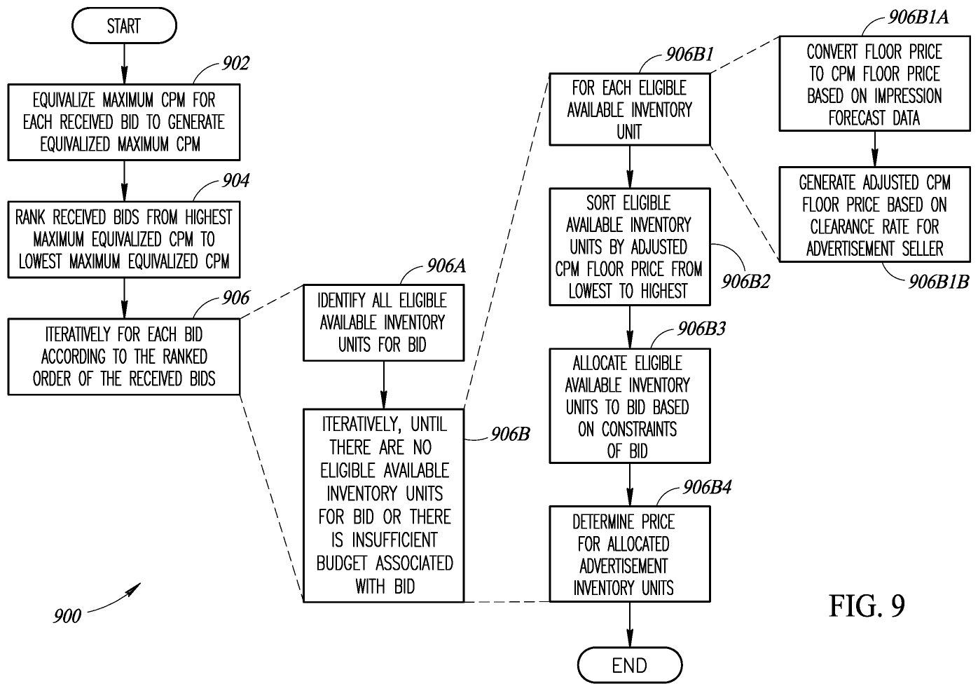

FIG. 9 is a flow diagram showing a method 900 of operating an auction engine of an automated advertisement purchase system to determine which bid wins which available inventory unit, according to one non-limiting illustrated implementation. At 902, the system may, for each of the received bids, equivalize the maximum CPM to generate a equivalized maximum CPM. At 904, the system may rank the received bids from highest maximum equivalized CPM to lowest maximum equivalized CPM. At 906, the system may iteratively, for each bid according to the ranked order of the received bids, perform acts 906A and 906B.

At 906A, the system identifies all eligible available inventory units for the bid. At 906B, the system iteratively, until there are no eligible available inventory units for the bid or there is insufficient budget associated with the bid, performs acts 906B1-906B4.

At 906B1, for each of the eligible available inventory units, the system may perform the acts 906B1A and 906B1B. At 906B1A, the system may convert the floor price to a CPM floor price based on impression forecast data. At 906B1B, the system may generate an adjusted CPM floor price based on a clearance rate for the advertisement seller.

At 906B2, the system sorts the eligible available inventory units by the adjusted CPM floor price from lowest to highest. At 906B3, the system allocates the eligible available inventory units to the bid based on constraints of the bid. At 906B4, the system determines a price for each of the allocated advertisement inventory units, using a process discussed above with reference to FIGS. 2 and 3.

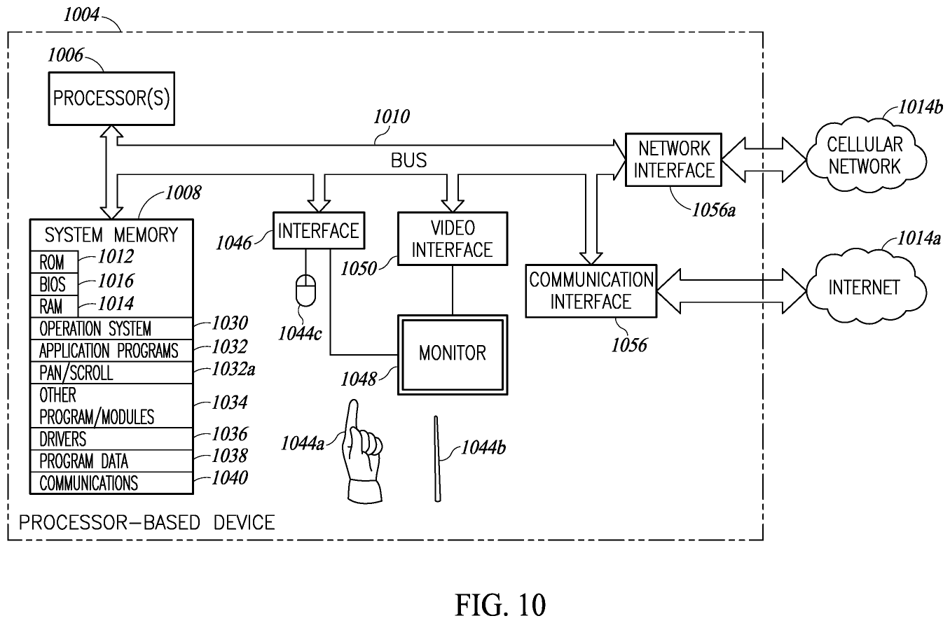

FIG. 10 shows a processor-based device 1004 suitable for implementing the various functionality described herein. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (“PCs”), network PCs, minicomputers, mainframe computers, and the like.

The processor-based device 1004 may include one or more processors 1006, a system memory 1008 and a system bus 1010 that couples various system components including the system memory 1008 to the processor(s) 1006. The processor-based device 1004 will at times be referred to in the singular herein, but this is not intended to limit the implementations to a single system, since in certain implementations, there will be more than one system or other networked computing device involved. Non-limiting examples of commercially available systems include, but are not limited to, ARM processors from a variety of manufactures, Core microprocessors from Intel Corporation, U.S.A., PowerPC microprocessor from IBM, Sparc microprocessors from Sun Microsystems, Inc., PA-RISC series microprocessors from Hewlett-Packard Company, 68xxx series microprocessors from Motorola Corporation.

The processor(s) 1006 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 10 are of conventional design. As a result, such blocks need not be described in further detail herein, as they will be understood by those skilled in the relevant art.

The system bus 1010 can employ any known bus structures or architectures, including a memory bus with memory controller, a peripheral bus, and a local bus. The system memory 1008 includes read-only memory (“ROM”) 1012 and random access memory (“RAM”) 1014. A basic input/output system (“BIOS”) 1016, which can form part of the ROM 1012, contains basic routines that help transfer information between elements within processor-based device 1004, such as during start-up. Some implementations may employ separate buses for data, instructions and power.

The processor-based device 1004 may also include one or more solid state memories, for instance Flash memory or solid state drive (SSD) 1018, which provides nonvolatile storage of computer-readable instructions, data structures, program modules and other data for the processor-based device 1004. Although not depicted, the processor-based device 1004 can employ other nontransitory computer- or processor-readable media, for example a hard disk drive, an optical disk drive, or memory card media drive.

Program modules can be stored in the system memory 1008, such as an operating system 1030, one or more application programs 1032, other programs or modules 1034, drivers 1036 and program data 1038.

The application programs 1032 may, for example, include panning/scrolling 1032a. Such panning/scrolling logic may include, but is not limited to logic that determines when and/or where a pointer (e.g., finger, stylus, cursor) enters a user interface element that includes a region having a central portion and at least one margin. Such panning/scrolling logic may include, but is not limited to logic that determines a direction and a rate at which at least one element of the user interface element should appear to move, and causes updating of a display to cause the at least one element to appear to move in the determined direction at the determined rate. The panning/scrolling logic 1032a may, for example, be stored as one or more executable instructions. The panning/scrolling logic 1032a may include processor and/or machine executable logic or instructions to generate user interface objects using data that characterizes movement of a pointer, for example data from a touch-sensitive display or from a computer mouse or trackball, or other user interface device.

The system memory 1008 may also include communications programs 1040, for example a server and/or a Web client or browser for permitting the processor-based device 1004 to access and exchange data with other systems such as user computing systems, Web sites on the Internet, corporate intranets, or other networks as described below. The communications programs 1040 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 10 as being stored in the system memory 1008, the operating system 1030, application programs 1032, other programs/modules 1034, drivers 1036, program data 1038 and server and/or browser 1040 can be stored on any other of a large variety of nontransitory processor-readable media (e.g., hard disk drive, optical disk drive, SSD and/or flash memory).

A user can enter commands and information via a pointer, for example through input devices such as a touch screen 1048 via a finger 1044a, stylus 1044b, or via a computer mouse or trackball 1044c which controls a cursor. Other input devices can include a microphone, joystick, game pad, tablet, scanner, biometric scanning device, etc. These and other input devices (i.e.,“I/O devices”) are connected to the processor(s) 1006 through an interface 1046 such as touch-screen controller and/or a universal serial bus (“USB”) interface that couples user input to the system bus 1010, although other interfaces such as a parallel port, a game port or a wireless interface or a serial port may be used. The touch screen 1048 can be coupled to the system bus 1010 via a video interface 1050, such as a video adapter to receive image data or image information for display via the touch screen 1048. Although not shown, the processor-based device 1004 can include other output devices, such as speakers, vibrator, haptic actuator, etc.

The processor-based device 1004 may operate in a networked environment using one or more of the logical connections to communicate with one or more remote computers, servers and/or devices via one or more communications channels, for example, one or more networks 1014a, 1014b. These logical connections may facilitate any known method of permitting computers to communicate, such as through one or more LANs and/or WANs, such as the Internet, and/or cellular communications networks. Such networking environments are well known in wired and wireless enterprise-wide computer networks, intranets, extranets, the Internet, and other types of communication networks including telecommunications networks, cellular networks, paging networks, and other mobile networks.

When used in a networking environment, the processor-based device 1004 may include one or more wired or wireless communications interfaces 1014a, 1014b (e.g., cellular radios, WI-FI radios, Bluetooth radios) for establishing communications over the network, for instance the Internet 1014a or cellular network.

In a networked environment, program modules, application programs, or data, or portions thereof, can be stored in a server computing system (not shown). Those skilled in the relevant art will recognize that the network connections shown in FIG. 10 are only some examples of ways of establishing communications between computers, and other connections may be used, including wirelessly.

For convenience, the processor(s) 1006, system memory 1008, network and communications interfaces 1014a, 1014b are illustrated as communicably coupled to each other via the system bus 1010, thereby providing connectivity between the above-described components. In alternative implementations of the processor-based device 1004, the above-described components may be communicably coupled in a different manner than illustrated in FIG. 10. For example, one or more of the above-described components may be directly coupled to other components, or may be coupled to each other, via intermediary components (not shown). In some implementations, system bus 1010 is omitted and the components are coupled directly to each other using suitable connections.

The foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Those of skill in the art will recognize that many of the methods or algorithms set out herein may employ additional acts, may omit some acts, and/or may execute acts in a different order than specified.

In addition, those skilled in the art will appreciate that the mechanisms taught herein are capable of being distributed as a program product in a variety of forms, and that an illustrative implementation applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method to automate advertisement placement in linear mediacasts, the method comprising:
providing an automated auction-based marketplace for advertisement slots within a future time period;
receiving, from a plurality of advertisement sellers, a plurality of available inventory units, each of the available inventory units specifying at least one of the advertisement slots and a floor price;
receiving, from each of a plurality of advertisement buyers, a plurality of bids for the advertisement slots, each of the bids specifying one or more of the advertisement slots and a maximum cost per mille (CPM) that the advertisement buyer is willing to pay for an advertisement slot;
responsive to a tentative auction trigger, executing an auction engine to automatically generate auction results, the auction results indicating, for each advertisement slot, which bid would win which available inventory unit and a price that the winning advertisement buyer would pay for the available inventory unit;
presenting the auction results generated responsive to the tentative auction trigger to the advertisement sellers and the advertisement buyers as tentative auction results;
responsive to a final auction trigger,
executing the auction engine to automatically generate auction results;
designating auction results for advertisement slots within a determined time period after the final auction trigger as final auction results; and
designating auction results for advertisement slots beyond the determined time period after the final auction trigger as tentative auction results; and
presenting the final auction results and the tentative auction results to the advertisement sellers and the advertisement buyers.

2. The method of claim 1, further comprising:
generating orders based on the final auction results; and
sending the generated orders to a traffic management system for publishing.

3. The method of claim 1, further comprising:
rejecting any bids within the determined time period after the final auction trigger that were not accepted based on the final auction results.

4. The method of claim 1 wherein each of the bids specifies at least one of the advertisement slots and a maximum CPM for a household demographic that the advertisement buyer is willing to pay.

5. The method of claim 1, further comprising:
for each specified maximum CPM, equivalizing the maximum CPM by length of advertisement slot to obtain an equivalized maximum CPM.

6. The method of claim 1 wherein the auction engine takes into account at least one of: a budget of the advertisement buyer, a frequency cap of the advertisement buyer, or a minimum spot frequency count of the advertisement buyer.

7. The method of claim 1 wherein the auction engine converts each floor price into equivalized CPM based on impression forecast data and advertisement spot length.

8. The method of claim 1 wherein each of the available inventory units specifies seller accept rules that define at least one of: advertisement spot lengths the advertisement seller is willing to sell, agencies to exclude, or advertisers to exclude.

9. The method of claim 1 wherein the floor price specified by at least one of the available inventory units is a fixed floor price or a dynamic floor price based on previously sold inventory.

10. The method of claim 1 wherein the final auction trigger occurs on a closing day and, responsive to the final auction trigger, the auction engine generates final auction results for a determined number of days that occur one or more days after the closing day.

11. The method of claim 1 wherein the tentative auction trigger occurs responsive to at least one of: the daily close of the auction marketplace, receiving a bid from an advertisement buyer, or receiving a new accept rule from an advertisement seller.

12. The method of claim 1 wherein the auction engine determines the auction results based at least in part on a clearance rate for each of the advertisement sellers, the clearance rate indicative of a percentage of bids previously accepted by the advertisement seller that were actually published.

13. The method of claim 1 wherein presenting the tentative auction results comprises presenting to the advertisement buyers the number of impressions for each advertisement seller and daypart and an amount of an overall budget that the advertisement buyer has tentatively spent.

14. The method of claim 1 wherein, to determine a price that the winning advertisement buyer would pay for the available inventory unit, the auction engine takes into account at least one of: a floor price of a non-winning advertisement seller or the maximum CPM of a non-winning advertisement buyer.

15. The method of claim 14 wherein the non-winning advertisement seller is the advertisement seller that has a second lowest floor price, and the non-winning advertisement buyer is the advertisement buyer that has the second highest maximum CPM.

16. The method of claim 1 wherein, to determine which bid wins which available inventory unit, the auction engine performs actions including:
for each of the received bids, equivalizing the maximum CPM to generate a equivalized maximum CPM;
ranking the received bids from highest maximum equivalized CPM to lowest maximum equivalized CPM;
iteratively for each bid according to the ranked order of the received bids,
identifying all eligible available inventory units for the bid;
iteratively, until there are no eligible available inventory units for the bid or there is insufficient budget associated with the bid,
for each of the eligible available inventory units,
converting the floor price to a CPM floor price based on impression forecast data; and
generating an adjusted CPM floor price based on a clearance rate for the advertisement seller;
sorting the eligible available inventory units by the adjusted CPM floor price from lowest to highest;
allocating the eligible available inventory units to the bid based on constraints of the bid; and
determining a price for each of the allocated advertisement inventory units.

17. The method of claim 1 wherein, to determine a price that the winning advertisement buyer would pay for the available inventory unit, the auction engine performs actions including:
if there is both a second lowest seller floor price and a second highest maximum CPM, setting the price equal to the mean of the second lowest seller floor price and the second highest maximum CPM adjusted by a first adjustment factor;
if there is not a second lowest seller floor price and there is a second highest maximum CPM, setting the price equal the mean of the lowest seller floor price and the second highest maximum CPM adjusted by a second adjustment factor;
if there is a second lowest seller floor price and there is not a second highest maximum CPM, setting the price equal to the second lowest seller floor price; and
if there is not a second lowest seller floor price and there is not a second highest maximum CPM, setting the price equal to the lowest seller floor price.

18. The method of claim 17, wherein the maximum CPMs are equivalized maximum household CPMs.

19. The method of claim 17, wherein the first adjustment factor is one of multiplied by or added to the mean of the second lowest seller floor price and the second highest maximum CPM, the second adjustment factor is one of multiplied by or added to the mean of the lowest seller floor price and the second highest maximum CPM, and each of the first and second adjustment factors is zero, a positive number, or a negative number.

20. The method of claim 17 wherein the first adjustment factor is equal to the second adjustment factor.

21. The method of claim 17 wherein the first adjustment factor and the second adjustment factor comprise randomly generated numbers.

22. A system to optimize advertisement placement in linear mediacasts for a seller of advertisements, the system comprising:
at least one nontransitory processor-readable storage medium that stores at least one of instructions or data; and
at least one processor communicatively coupled to the at least one nontransitory processor-readable storage medium, in operation, the at least one processor:
provides an automated auction-based marketplace for advertisement slots within a future time period;
receives, from a plurality of advertisement sellers, a plurality of available inventory units, each of the available inventory units specifying at least one of the advertisement slots and a floor price;
receives, from each of a plurality of advertisement buyers, a plurality of bids for the advertisement slots, each of the bids specifying one or more of the advertisement slots and a maximum cost per mille (CPM) that the advertisement buyer is willing to pay for an advertisement slot;
responsive to a tentative auction trigger, executes an auction engine to automatically generate auction results, the auction results indicating, for each advertisement slot, which bid would win which available inventory unit and a price that the winning advertisement buyer would pay for the available inventory unit;
presents the auction results generated responsive to the tentative auction trigger to the advertisement sellers and the advertisement buyers as tentative auction results;
responsive to a final auction trigger,
executes the auction engine to automatically generate auction results;
designates auction results for advertisement slots within a determined time period after the final auction trigger as final auction results; and
designates auction results for advertisement slots beyond the determined time period after the final auction trigger as tentative auction results; and
presents the final auction results and the tentative auction results to the advertisement sellers and the advertisement buyers.

23. A nontransitory processor-readable storage medium that stores at least one of instructions or data, the at least one nontransitory processor-readable storage medium, when executed by at least one processor, cause the at least one processor to:
provide an automated auction-based marketplace for advertisement slots within a future time period;
receive, from a plurality of advertisement sellers, a plurality of available inventory units, each of the available inventory units specifying at least one of the advertisement slots and a floor price;
receive, from each of a plurality of advertisement buyers, a plurality of bids for the advertisement slots, each of the bids specifying one or more of the advertisement slots and a maximum cost per mille (CPM) that the advertisement buyer is willing to pay for an advertisement slot;
responsive to a tentative auction trigger, execute an auction engine to automatically generate auction results, the auction results indicating, for each advertisement slot, which bid would win which available inventory unit and a price that the winning advertisement buyer would pay for the available inventory unit;
present the auction results generated responsive to the tentative auction trigger to the advertisement sellers and the advertisement buyers as tentative auction results;
responsive to a final auction trigger,
execute the auction engine to automatically generate auction results;
designate auction results for advertisement slots within a determined time period after the final auction trigger as final auction results; and
designate auction results for advertisement slots beyond the determined time period after the final auction trigger as tentative auction results; and
present the final auction results and the tentative auction results to the advertisement sellers and the advertisement buyers.
